(19) United States
(12) Patent Application Publication
(10) Pub. No.: US 2021/0360979 A1
(43) Pub. Date: Nov. 25, 2021

(54) Domestic Extracting Machine for Herbs Capsule

(71) Applicants: David Leb, Panama (PA); Assaf Bivas, Pardes Hana Karkur (IL)

(72) Inventors: David Leb, Panama (PA); Assaf Bivas, Pardes Hana Karkur (IL)

(21) Appl. No.: 16/981,206

(22) PCT Filed: Mar. 14, 2019
(86) PCT No.: PCT/IL2019/050285

§ 371 Date: Sep. 15, 2020

(30) Foreign Application Priority Data
Mar. 21, 2018 (IL) 258287

(51) Int. Cl. A24F 40/57; A61K 36/18; A61J 1/14; A24F 40/42; A24F 40/46; A24B 15/24; B65D 85/804

(52) U.S. Cl. CPC A24F 40/57; A61K 36/18; A61J 1/14; A61J 2200/42; A24F 40/46; A24B 15/24; B65D 85/804; A24F 40/42

(57) ABSTRACT

A domestic extracting machine that is designed to extract herbs contained in a capsule, which includes: a capsule-compartment, a condensation-compartment, an air blower, a heating mechanism, a stirring mechanism, and a control mechanism. The capsule is designed to contain the herbs and includes perforations and an opening closed by a cover.

### TECHNICAL FIELD

The present invention refers to a domestic extracting machine for herbs capsules.

### BACKGROUND ART

There are many types of herbs that users wish to consume their extract by vaporization process, such as tobacco, cannabis, chamomile, lavender, green tea, and others. The present patent application discloses a domestic extracting machine that enables users to extract herbs that contained in capsules.

### DESCRIPTION OF THE DRAWINGS

The intention of the drawings attached to the application is not to limit the scope of the invention and its application. The drawings are intended only to illustrate the invention and they constitute only one of its many possible implementations.

FIGS. 1 and 2 depict the appearance of the domestic extracting machine (1).

FIG. 3 depicts the capsule (100).

FIG. 4 is a schematic description of the capsule (100) inside the capsule compartment.

FIG. 5 is a schematic depiction of the upper rim (108) with two pins (1081) and the peripheral recess (25) with two holes (251).

FIG. 6 is a schematic depiction of the domestic extracting machine (1).

FIG. 7 depicts a rear view of the domestic extracting machine (1).

### THE INVENTION

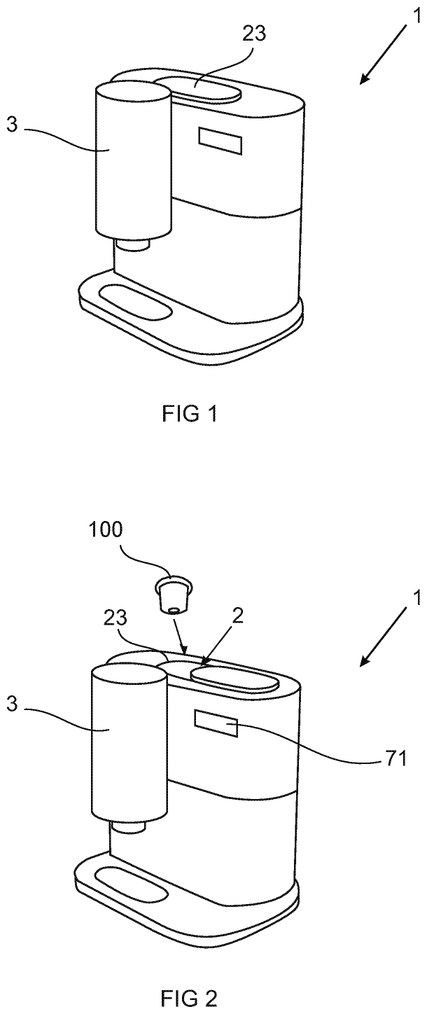

The object of the present invention is to provide a domestic extracting machine (1) from herbs, which is designed to extract herbs contained in a capsule. The machine (1) is designed to serve mainly for personal use when a user needs a small amount of extract from relatively small capsule and not industrially. The domestic extracting machine (1) includes a capsule-compartment (2), a condensation-compartment (3), an air blower (4), a heating mechanism (5), a stirring mechanism (6) and a cutting means (9) such as a knife or any rigid object that capable to cut a paper cover of the capsule. The domestic extracting machine (1) is also includes a control mechanism (7) and a power source (8), which may be an inner battery or a connection to external power source. FIGS. 1 and 2 describe a possible exterior appearance of the domestic extracting machine (1).

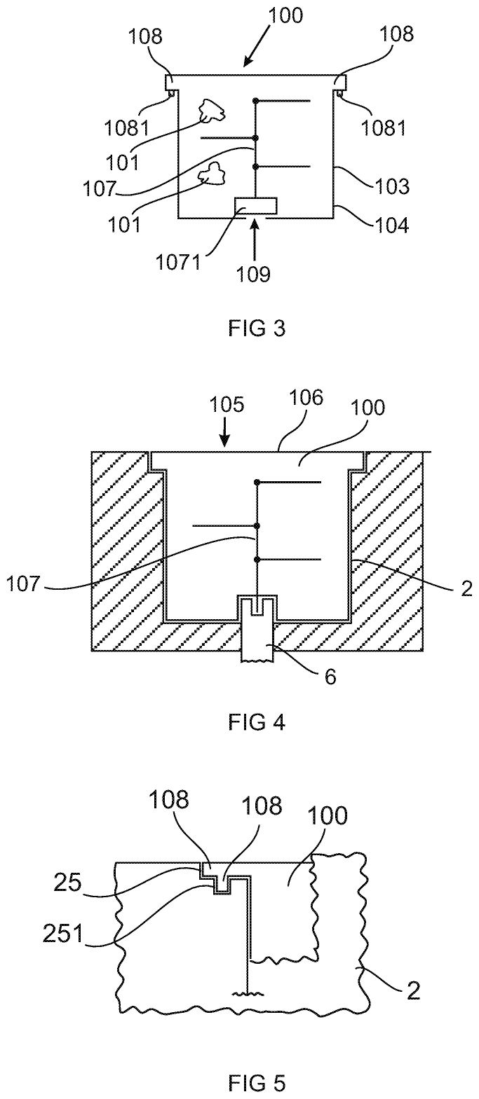

The capsule (100), which is preferably be made of stainless steel paper, possible with a thickness of 0.05 millimeters, is designed to contain herb (101). The capsule includes perforations (102) on its side wall (103). It is preferably that the perforations (102) will be on the lower part (104) of the capsule (100) possible on the perimeter of its side wall (103) and preferably that their diameter's pores will be of about 200-500 microns. The capsule (100) also includes an opening (105) which closed by a cover (106), preferably made of material that can be easily punctured such as a paper lid. The capsule (100) also includes a stirring arm (107). FIG. 3 depicts the capsule (100).

The capsule-compartment (2) is designed to receive the capsule (100) and its wall (21) includes hot-air opening (22) through which hot air flows from the air blower (4) into the capsule-compartment (2) and into the capsule (100) through the perforations (102). The capsule-compartment (2) is also includes an insert-opening (23), through which the capsule (100) is inserted inside it, and outlet-opening (24) through which the vapors flows from the capsule-compartment (2) into the condensation-compartment (3). The air blower (4) is designed to pump air into the hot-air opening (22) and the heating mechanism (5) is designed to heat that air that is pumped into the hot-air opening (22). FIG. 4 is a schematic description of the capsule (100) inside the capsule compartment.

The capsule (100) may include an upper rim (108) that corresponds with a peripheral recess (25) at the upper part of the capsule compartment (2). It is also possible that the upper rim (108) may include one or more pins (1081) that correspond with holes (251) on the peripheral recess (25), as depicted for example in FIG. 5. When the capsule is inserted into the capsule-compartment, the upper rim of the capsule is positioned in the peripheral recess of the capsule-compartment and the pins (1081) are positioned inside the holes (251), and in addition the stirring mechanism (6) is in connection with the stirring arm (107).

The stirring mechanism (6), which is designed to be rotated by a stirring activator (63), is designed to be connected to the stirring arm (107), possible by corresponding pin and hole, preferably that have polygonal structure and not rounded so that the stirring mechanism (6) may easily connect to and rotate the stirring arm (107). The activator (63) is designed to rotate the stirring mechanism (6) that in turns rotates the stirring arm (107) that whirl the herbs (101) in the capsule (100), while the hot air flow from the air blower (4) through the capsule (100) into the condensation-compartment (3).

The hot air that flows through the capsule (100) heats the herbs (101) to a temperature where it does not burn (combust), but reaches a temperature high enough to release from the herbs vapors with their active ingredients, that includes also dirt particles, and these vapors flow into the condensation-compartment (3).

The condensation-compartment (3) includes condensation mechanism (31), which is designed to thicken the vapors that contain the active ingredients of the herbs and turn them into a liquid state such as drops or wax. The condensation-compartment (3) is also includes a collection tray (32) that receive the extract of the herbs as drops or wax from the condensation mechanism (31). The condensation-compartment (3) is also includes a sweeper mechanisms (33) that collect and drainage the dirt from the vapors, and an air filter (34) that filter the air that flow outside through air outlet opening (341). The structures of condensation mechanisms and condensers are known in the art and it seems that it is not necessary to detail this condensation mechanism (31), which may include for example cooling devices or cooling ribs or a pipe that may include such ribs. In general, the process in the condensation-compartment (3) includes the condensing of the vapors into drops or wax and releasing the air outside through the air filter.

The control mechanism (7) controls the operation of the domestic extracting machine (1) and its components. The control mechanism (7) controls the temperature of the hot air, may control the pressure of the hot air that flows into the capsule (100), activates the stirring mechanism (6), and the time period of the extracting process each time, possible, according the kind of herbs in the capsule and according the preference of the user to receive the extract as drops or as wax. The control mechanism (7) may include touch screen (71) for controlling the machine and processor.

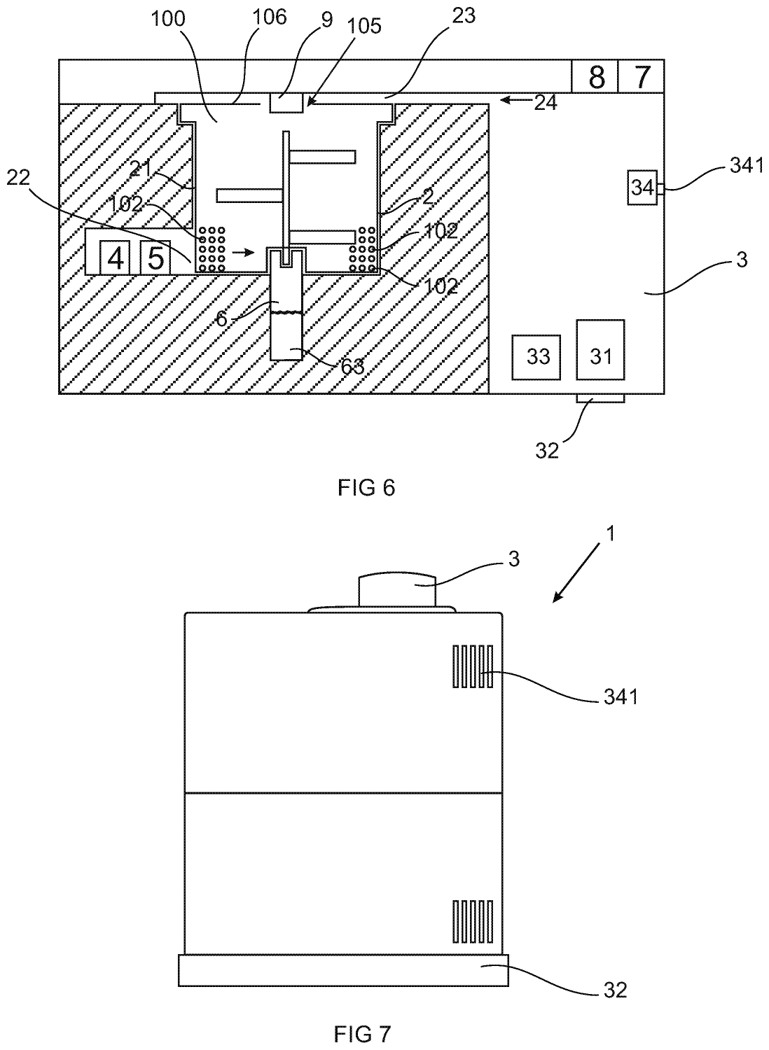

Operation of the domestic extracting machine (1): the user inserts the capsule (100) into the capsule-compartment (2) and closes the cover of this compartment, which may designed for example as a sliding drawer; the user sets the parameters of the extracting process by the control mechanisms (7); the stirring mechanism (6) rotates the stirring arm (107) that whirls the herbs inside the capsule while the air blower and the heating mechanism pump hot air under a certain pressure into the capsule; the vapors flows into the condensation-compartment in which the vapors turns into drops or wax that contain the active ingredients of the herbs. In the end of the process the user can remove the capsule and insert a new one for the next need. FIG. 6 is a schematic depiction of the domestic extracting machine (1) and its components, and FIG. 7 depicts a rear view of the domestic extracting machine (1).

1. A domestic extracting machine that is designed to extract herbs contained inside a capsule, comprising: a capsule-compartment that is designed to receive the capsule, a condensation-compartment, an air blower, a heating mechanism, a stirring mechanism, a stirring activator, and a control mechanism;
wherein said capsule-compartment includes a hot-air holes through which hot air can flows from the air blower into the capsule through perforations in the capsule, and an outlet-opening through which vapors can flows from the capsule into the condensation-compartment;
wherein the stirring activator is designed to rotate the stirring mechanism that in turns can rotate a stirring arm that is positioned inside the capsule and by that to whirl the herbs inside the capsule;
wherein the air blower is designed to blow air that can be heated by the heating mechanism, wherein the hot air can flow through the capsule and heat and vaporize the herbs wherein the vapors include active ingredients that can now into the condensation-compartment;
wherein the condensation-compartment (3) includes condensation mechanism that is designed to thicken the vapors; into a
wherein said control mechanism is designed to control the operation of the domestic extracting machine, to activate the air blower, the heating mechanism, and the stirring activator. from the vapors, an

[symbol]

2. A capsule containing herbs that corresponds with a domestic extracting machine that is designed to extract the herbs, wherein the capsule includes perforations on a side wall of the capsule that are designed to enable hot air from the domestic extracting machine to flows inside the capsule and a stirring arm inside the capsule that is designed to be rotated by a stirring mechanism of the domestic extracting machine.
